(19) United States
(12) Patent Application Publication
(10) Pub. No.: US 2023/0417225 A1
(43) Pub. Date: Dec. 28, 2023

(54) AUXILIARY COMBINED REGENERATOR (ACR)

(71) Applicant: Oleg Yuryevich NEIMYSHEV, Tyumen (RU)

(72) Inventor: Oleg Yuryevich NEIMYSHEV, Tyumen (RU)

(21) Appl. No.: 18/037,232

(22) PCT Filed: May 30, 2022
(86) PCT No.: PCT/RU2022/050171

§ 371 Date: May 16, 2023

(30) Foreign Application Priority Data
May 31, 2021 (RU) 2021115498

(51) Int. Cl. F03G 3/08; H02K 7/02; H02K 7/10; H02K 7/108; H02K 7/116; H02K 7/18

(52) U.S. Cl. CPC F03G 3/08; H02K 7/02; H02K 7/1004; H02K 7/108; H02K 7/116; H02K 7/183

(57) ABSTRACT

The invention may be used in transport, domestic, production and other spheres of human activities as an auxiliary source of electric energy. Auxiliary combined regenerator that comprises a housing having a rotatable main shaft installed therein which is kinematically connected with an alternator, as well as an impeller, top and bottom vertical motion areas, and a horizontal motion area connected in series with the shaft. The technical result is represented by improvement of performance and usability of a device in part of electric energy outfeed by enhancement of the device functionality in terms of possibilities to extract mechanical energy of different nature for further conversion thereof.

The invention may be used in transport, domestic, production and other spheres of human activities as an auxiliary source of electric energy.

Particularly, a vehicle battery charging system is known in the art that uses ram air and is disclosed in U.S. Pat. No. 5,680,032. The principle of operation of such system is based on the fact that, in the course of vehicle movement, ram air rotates turbines installed thereon. In turn, mechanical rotational energy is converted into the electric one by means of an appropriate system, and this energy is used to charge standard batteries of a transportation system.

Additionally, the system comprises at least one flywheel installed on a vertical shaft that may rotate around the latter. In the process of vehicle forward motion, a portion of rotational energy is transmitted to the flywheel by means of an appropriate kinematic link, and the former accumulates mechanical energy when rotated. When a vehicle slows down or stops, the air flow ramming the turbines reduces respectively, thus decreasing the energy of their rotation.

However, the flywheel keeps rotating, and thereby the rotational energy accumulated by it is also converted into the electric one which is used to charge the above-mentioned batteries.

The disadvantage of the known and similar systems is dependence on a single energy source represented by wind load, unavailability of a mechanical accumulator and impossibility to use vibrations, oscillatory and similar motion to convert the energy of such motion into usable energy and, consequently, its low performance.

The problem to be solved by the invention claimed is further improvement of devices of this class, however, the technical result achieved by means of solution to this problem is represented by improvement of performance and usability of a device in part of electric energy outfeed by enhancement of the device functionality in terms of possibilities to extract mechanical energy of different nature for further conversion thereof.

To achieve the set result, an auxiliary combined regenerator is provided which comprises a housing having a rotatable main shaft installed therein which is kinematically connected with an alternator, as well as an impeller, top and bottom horizontal motion areas, and a vertical motion area connected in series with the shaft, where:
the impeller is installed by means of an overrunning clutch on the top end of the main shaft protruding from the housing;
the main shaft passes through the top and bottom horizontal motion areas and the vertical motion area, and it is oriented perpendicularly to these areas;
one end of the top horizontal motion area is installed in the housing by means of a hinge, may roll within a horizontal plane in relation to the main shaft and is kinematically connected with a gear which is installed on the main shaft by means of the overrunning clutch;
one end of the bottom horizontal motion area is installed in the housing by means of a hinge, may perform reciprocating motion in relation to the main shaft and is kinematically connected with a gear which is installed on the main shaft by means of the overrunning clutch;
one end of the vertical motion area is installed in the housing by means of a hinge with possibility of rolling within a vertical plane, and its opposite end is connected with at least one first pneumatic cylinder placed in the housing that may be compressed;
however, said at least one first pneumatic cylinder is pneumatically connected with a pneumatic motor installed in the housing which is kinematically connected with a pulley that, in turn, is installed on the main shaft by means of the overrunning clutch;
the disc-shaped mechanical accumulator (flywheel) is installed on the main shaft.

Vertical Motion Area May be Connected with the Bottom Horizontal Motion Area Providing the Possibility to Convert Rolling Motion of the Vertical Motion Area into Reciprocating Motion of the Bottom Horizontal Motion Area;
on its opposite end, the top horizontal motion area may be connected with at least one second pneumatic cylinder placed in the housing that may be compressed; however, said pneumatic cylinder is also pneumatically connected with a receiver placed in the housing that accumulates the pressure and transmits it to the pneumatic motor;
on its opposite end, the bottom horizontal motion area may be connected with at least one third pneumatic cylinder placed in the housing that may be compressed; however, said pneumatic cylinder is also pneumatically connected with the pneumatic motor placed in the housing;
where the impeller may be covered with a shell allowing for through flow of air; where a compressible/releasable spring may be installed inside each pneumatic cylinder in contact with opposite inner walls.

The idea forming the basis of the invention claimed is based on regeneration of interaction energy of the device—regenerator and object it is installed on (surface, water and/or aircraft, building, etc.), as well as ambient forces, such as oncoming wind streams, gravitation force, pressure drops, etc., into usable energy, namely, electric energy that will be further used as an additional (auxiliary) energy for the main power source. A simple example explaining the nature of interaction mentioned above is, for instance, a car designed for any purpose with the regenerator claimed being installed on its roof, or a marine vessel fitted with such means. It is obvious that motion of a car/vessel is naturally accompanied by occurrence of ram air flows, vibrations of different nature, left/right turns, etc. By means of conversion, the energy produced in such cases is transmitted to the shaft with a disc-shaped mechanical accumulator attached thereto by through the system of overrunning clutches, drives, levers (see below), and further to the generator converting the mechanical energy of rotation into the electric one.

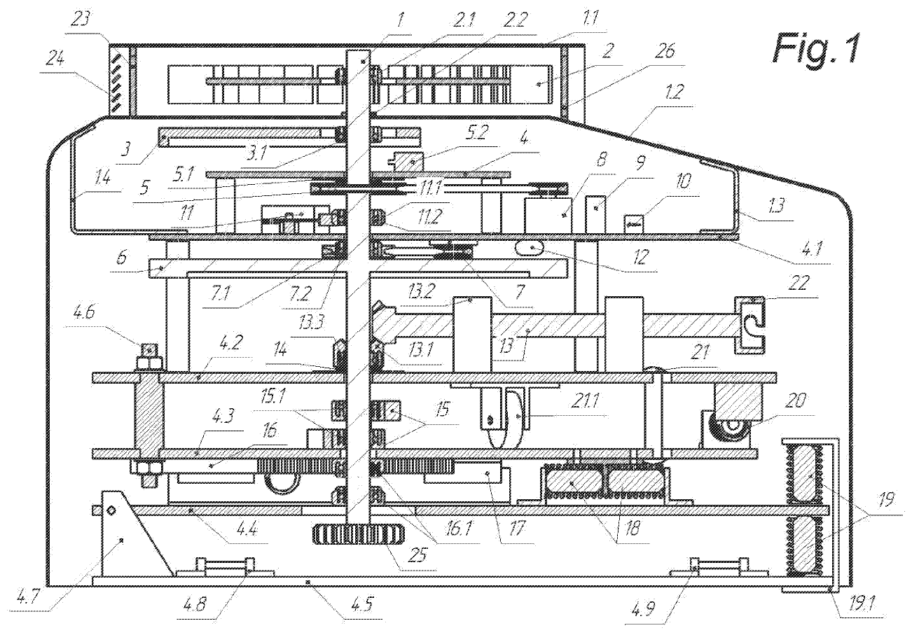

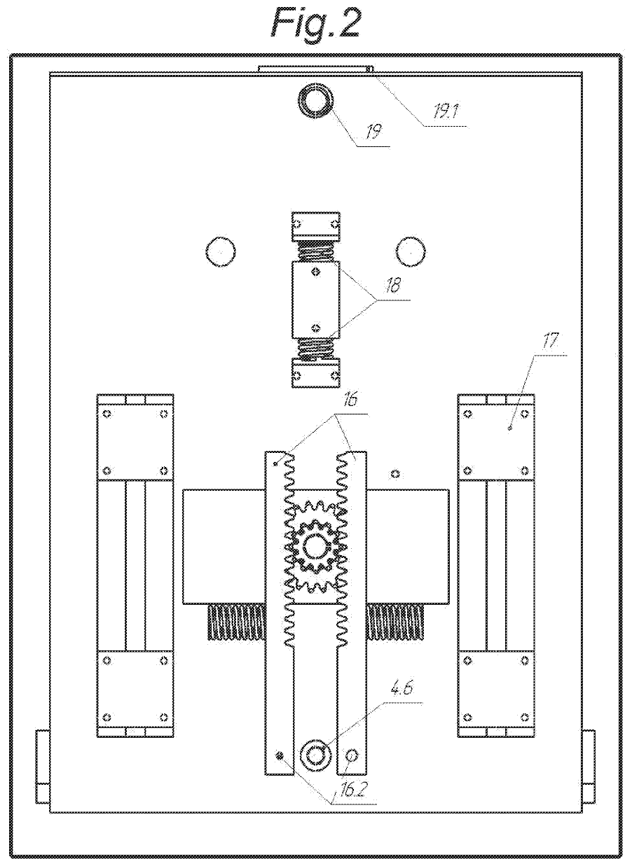

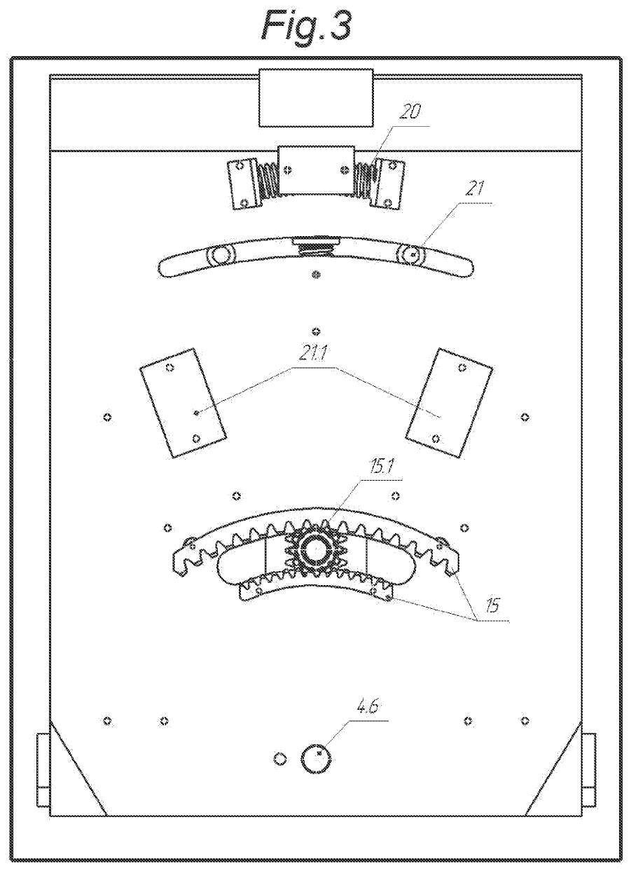

The design of the regenerator claimed is explained in the general sectional view in FIG. 1, as well as conditional schematic top views of the bottom area—FIG. 2, and the top area—FIG. 3 of the vertical motion area.

### THE FIGURES ILLUSTRATE THE FOLLOWING STRUCTURAL ELEMENTS OF THE REGENERATOR

1—main shaft;
1.1—outer shell;
1.2—inner shell (housing);
1.3, 1.4—inner shell attachments;
2—impeller;
2.1—first overrunning clutch;
2.2—inner shell gland;
3—off-centered segment;
3.1—second overrunning clutch;
4—rigid axle top plate;
4.1—rigid axle bottom plate;
4.2—top horizontal motion area;
4.3—bottom horizontal motion area;
4.4—vertical motion area;
4.5—bottom load-bearing area;
4.6—horizontal rolling area;
4.7—vertical rolling area;
4.8, 4.9—attachment lugs;
5—generator drive pulley;
5.1—journal bearing;
5.2—revolution meter;
6—mechanical accumulator;
7—pneumatic motor;
7.1—pneumatic motor drive;
7.2—third overrunning clutch;
8—alternator;
9—invertor (rectifier);
10—battery;
11—barometric converter;
11.1—pulley;
11.2—fourth overrunning clutch;
12—receiver with intake header;
13—line shaft for external mechanical energy sources;
13.1—skew gerotor;
13.2—shaft attachment support;
13.3—fifth overrunning clutch;
14—journal bearing;
15—concave toothed bars for lateral oscillation conversion (left, right);
15.1—gears with overrunning clutches;
16—straight toothed bars for oscillation conversion (forward, backward), with rolling torque related to front axle, spring-actuated on the rear part leading to the main shaft;
16.1—mating gears with overrunning clutches;
16.2—toothed bar rolling contact bearing;
17—rocker bearings;
18, 19, 20—pneumatic cylinders with springs equipped with backpressure valves and hoses;
19.1—vertical motion area limit stop;
21—limit stop of the top and bottom horizontal motion areas in vertical plane;
21.1—horizontal journal bearings;
22, 25—clutches of the line shaft for external mechanical energy sources;
23—air filter;
24—louvers;
26—air outlet.

The key structural element of the auxiliary combined regenerator (ACR) is rotatable shaft 1 with disc-shaped mechanical accumulator 6 (flywheel) having its weight distributed over the edge. In turn, rotation is transmitted to the shaft through overrunning clutches 2.1, 3.1, 7.2, 11.2, and 13.3 (to ensure required direction of rotation), the system of gears and levers, overrunning clutches, and mechanical energy is accumulated that, in its turn, is transmitted to the alternator. Availability of said accumulating disc 6 is intended to ensure autorotation of shaft 1 for some period of time by inertial force in case there are no external impact sources and, as a consequence, to ensure temporary generation of electric energy. In turn, such rotation is ensured by interaction of the shaft with the regenerator elements through overrunning clutches by inertia (see the details below).

The shaft is installed on journal bearings between two plates 4, 4.1 rigidly attached to each other and forming an intermediate space where the drive pulley of generator 5 is installed on the shaft, as well as electric energy barometric converter 11 (used optionally), and plate 4.1 serves as a platform where alternator 8 (kinematically connected with pulley 5), electric inverter (rectifier) 9, battery 10, and pneumatic motor 7 are placed and connected with each other in series. Shaft ends protrude from plates 4 and 4.1, respectively. Segment 3 in the form of an off-centered circle sector is installed above plate 4 by means of overrunning clutch 3.1, and this segment converts and transmits to the shaft the oscillatory impulses occurring naturally, for example, during movement of a vehicle that may have the regenerator claimed installed thereon.

Plates and the segment cover the inner protective shell 1.2 above which there is the impeller 2 put on shaft 1 through clutch 2.1, for example, in the form of a disc with blades. The impeller serves for recovery of wind and ram air incoming through filter 23 that rotate the impeller and are exhausted through opening 26. It is obvious for a person skilled in the art that air flow direction illustrated in FIG. 1 is conventional. Examples of ram air may be represented by oncoming air flows occurring during movement of a vehicle equipped with the regenerator claimed, natural air flows in case the regenerator is installed on the roof of a residential or similar building, etc. In any case, the main factor is ensuring the rotation of flywheel, transmission of this rotation to the shaft and conversion of mechanical energy generated into the electric one according to the generally known physical laws.

Below the plate 4.1 there are the top horizontal motion area 4.2, bottom horizontal motion area 4.3 and vertical motion area 4.4 located from top to bottom, respectively, and each area is kinematically connected with the shaft 1 to convert appropriate energy into the shaft rotation.

One edge (end) of the vertical motion area 4.4 is positioned on the vertical rolling area (hinge) 4.7 that is essentially the trunnion for upward/downward rolling of the area, and its another edge is in contact with pneumatic cylinders 19 at top and bottom (in other words, it is clamped between said pneumatic cylinders). In turn, axle 4.7 and pneumatic cylinders 19 are placed at the bottom load-bearing area 4.5 that serves as the main load-bearing element of the entire regenerator. The simplest factor conditioning the functioning of such area is represented by upward/downward oscillatory movement of a vehicle due to irregularity of a road. An additional factor improving the efficiency of use of the vertical motion area is the weight of the regenerator itself that applies pressure on the area. In the course of said vertical oscillatory movement of the area 4.4 in relation to axle 4.7, the second end of the area ensures alternating compression of the pneumatic cylinders 19. Generated compressed air is fed to receiver 12 through a pneumatic line, and then to the pneumatic motor 7 kinematically connected with pulley 7.1 installed on shaft 1 by means of overrunning clutch 7.2.

Vertical motion area 4.4 is connected with the bottom horizontal motion area 4.3 through rocker bearings 17 that convert upward/downward movement of the area 4.4 into forward/backward movement of the area 4.3. Appropriate movement of area 4.3 is transmitted to straight toothed bars 16 attached to support 16.2 with a torque, and area 4.3 is positioned in such a way that it may move longitudinally in relation to axle 4.6, and the bars 16 are kinematically connected with gear 16.1 that is installed on shaft 1 by means of overrunning clutch. Additionally, area 4.3 is spring-actuated in relation to pneumatic cylinders 18, and the working principle of this junction “area 4.3-pneumatic cylinders 18” is similar to the working principle of junction “area 4.4-pneumatic cylinders 19”, except that area 4.3 moves reciprocally forward/backward as was mentioned above, thus ensuring respective compressing/releasing action on the pneumatic cylinders 18.

One end of the top horizontal motion area 4.2 is connected with the bottom horizontal motion area 4.3 by means of pivoted axle 4.6, and its other end rests against rocker bearings 21.1 converting movements to the right/left occurring, for example, when a vehicle takes a turn during movement. Arc-shaped toothed bars 15 are attached to area 4.2, and they are kinematically connected with gear 15.1 installed on shaft 1 by means of overrunning clutch. The end of area 4.2 that is opposite to the one connected with axle 4.6 is in contact with pneumatic cylinders 20, and the working principle of junction “area 4.2-pneumatic cylinders 20” is similar to the working principle of junction “area 4.4-pneumatic cylinders 19” described above.

1. An auxiliary combined regenerator that comprises a housing having a rotatable main shaft installed therein which is kinematically connected with an alternator, as well as an impeller, top and bottom horizontal motion areas, and a vertical motion area connected in series with the shaft, wherein:
the impeller is installed by means of an overrunning clutch on the top end of the main shaft protruding from the housing;
the main shaft passes through the top and bottom horizontal motion areas and the vertical motion area, and it is oriented perpendicularly to these areas;
one end of the top horizontal motion area is installed in the housing by means of a hinge, may roll within a horizontal plane in relation to the main shaft and is kinematically connected with a gear which is installed on the main shaft by means of the overrunning clutch;
one end of the bottom horizontal motion area is installed in the housing by means of a hinge, may perform reciprocating motion in relation to the main shaft and is kinematically connected with a gear which is installed on the main shaft by means of the overrunning clutch;
one end of the vertical motion area is installed in the housing by means of a hinge with possibility of rolling within a vertical plane, and its opposite end is connected with at least one first pneumatic cylinder placed in the housing that may be compressed;
however, said at least one first pneumatic cylinder is pneumatically connected with a pneumatic motor installed in the housing which is kinematically connected with a pulley that, in turn, is installed on the main shaft by means of the overrunning clutch;
the disc-shaped mechanical accumulator (flywheel) is installed on the main shaft.

2. The regenerator according to claim 1 wherein vertical motion area is connected with the bottom horizontal motion area providing the possibility to convert rolling motion of the vertical motion area into reciprocating motion of the bottom horizontal motion area.

3. The regenerator according to claim 1 wherein the opposite end of the top horizontal motion area is connected with at least one second pneumatic cylinder placed in the housing that may be compressed; and wherein said pneumatic cylinder is also pneumatically connected with a receiver placed in the housing that accumulates the pressure and transmits it to the pneumatic motor.

4. The regenerator according to claim 1 wherein the opposite end of the bottom horizontal motion area is connected with at least one third pneumatic cylinder placed in the housing that may be compressed; and wherein said pneumatic cylinder is also pneumatically connected with the pneumatic motor.

5. The regenerator according to claim 1 wherein the impeller is covered with a shell allowing for through flow of air.

6. The regenerator according to claim 1 wherein a compressible/releasable spring is installed inside each pneumatic cylinder in contact with opposite inner walls.
